(19) United States
(12) Patent Application Publication
(10) Pub. No.: US 2015/0098130 A1
(43) Pub. Date: Apr. 9, 2015

(54) SHAKING CORRECTION DEVICE

(71) Applicants: Huizhou Dayawan Ever Bright Electronic Industry Co., Ltd., Huizhou (CN); JSS Optical Technology Co., Ltd., HONG KONG (HK); Huizhou Daya Bay Jss Optical Technology.Co., Ltd., Huizhou (CN)

(72) Inventor: Kokichi Terajima, Tokyo (JP)

(21) Appl. No.: 14/499,110

(22) Filed: Sep. 27, 2014

(30) Foreign Application Priority Data
Oct. 7, 2013 (JP) 2013-210025

(51) Int. Cl. G02B 27/64; G02B 7/02

(52) U.S. Cl. CPC G02B 27/646; G02B 7/023
USPC 359/557

(57) ABSTRACT

The present invention aims to provide a shaking correction device which is the shaking correction device for a camera. The shaking correction device can be produced at a low cost without adding the assembling working procedure of the lens driving device, and the shaking correction device is of a simple structure whatever the size and mounting position of the lens driving device are. The shaking correction device comprises a first stator, a second stator, and a first movable part and a second movable part which are supported to be enabled to move by the first stator and the second stator. The first stator and the second stator are mounted in a frame body for retaining the lens driving device.

### CROSS-REFERENCE TO RELATED APPLICATIONS

This application claims priority to Japanese Application No. 2013-210025 filed on Oct. 7, 2013 in Japan Patent Office, the contents of which are incorporated by reference herein.

### BACKGROUND OF THE INVENTION

1. Field of the Invention

The present invention relates to a shaking correction device for correcting shaking generated by a lens driving device mounted in a mobile phone.

2. Description of Related Art

In recent years, mobile phones with various functions, particularly mobile phones provided with a camera are widely popularized. Besides an auto focus function, the camera mounted in the mobile phone is also seeking for a shaking correction function and the like through updating.

For example, by enabling a lens driving device for retaining a lens in the mobile phone with the camera to operate, the auto focus function can be realized, and the lens driving device can swing in the directions perpendicular to the optical axis of the lens, and thus shaking correction is realized.

A shaking correction device 310 as shown in FIG. 6 illustrates one example of a lens driving device 300 which is added with the shaking correction function and is suspended in a wire suspension manner. The shaking correction device 310 is assembled in the camera of the mobile phone so as to enable the lens driving device 300 with the auto focus function to swing. Namely, the shaking correction device 310 enables the lens 304 to move in the direction of the optical axis (Z axis direction) for focusing, and also enables the lens 304 and the lens driving device 300 to swing in the X axis direction and the Y axis direction which are orthogonal to the Z axis and are orthogonal to each other respectively, and thus shaking correction is realized.

The shaking correction device 310 as shown in FIG. 6 includes: four suspension electric wires 302 with one ends fixed at four corners of a base 301, a plurality of unshown permanent magnets mounted on the side face of the lens driving device 300 in the X axis direction, coils 303Y for shaking correction which are positioned closer to the outer side than the permanent magnets and are arranged opposite to the permanent magnets at an interval, a plurality of unshown permanent magnets mounted on the side face of the Y axis direction, and coils 303X for shaking correction which are positioned closer to the outer side than the permanent magnets and are arranged opposite to the permanent magnets at an interval.

The four suspension electric wires 302 extend along the front of the Z axis direction, and the other ends of the four suspension electric wires 302 are fixed on the front end of the lens driving device 300. Therefore, the four suspension electric wires 302 are used for supporting the lens driving device 300 so that the lens driving device 300 can swing along the X axis direction and the Y axis direction respectively.

According to the structure, the shaking correction device 310 utilizes the lens driving device 300 to enable the lens 304 to move to an appropriate position in the Z axis direction so as to focus on an object. And under the condition that an frame body of the mobile phone with the camera shakes (vibrations) in the X axis direction and the Y axis direction, the lens driving device 300 can also swing in the directions (Y axis direction and X axis direction) opposite to the vibration direction, and thus shaking correction is realized.

Specifically, when the unshown coils for auto focus are electrified, the coils for auto focus generate Lorentz force in the Z axis direction, and the lens driving device 300 can enable the lens 304 to move to the position in the Z axis direction so as to be balanced with restoring force of a plurality of wrist parts 305a of two plate springs 305. Moreover, the unshown permanent magnet and the coils 303Y for shaking correction which are oppositely arranged along the X axis direction are electrified, so that the shaking correction device 310 can enable the lens driving device 300 to swing in the Y axis direction. Moreover, the unshown permanent magnet and the coils 303X for shaking correction which are oppositely arranged along the Y axis direction are electrified, so that the shaking correction device 310 can enable the lens driving device 300 to swing in the X axis direction (such as referring to patent documentation 1: JP Patent 2011-65140).

In the above-mentioned lens driving device 300, characteristic inspection of the auto focus function and the like are carried out after the lens driving device 300 is assembled, and after only mechanisms with normal operations are transferred to the next working procedure, components with the shaking correction function are assembled. Thus, the shaking correction device 310 as shown in FIG. 6 is designed.

However, during the assembling working procedure that the components for shaking correction are added, the wrist parts 305a of the plate springs 305 are easily damaged during the assembling process, and if the wrist parts 305a are damaged, the lens driving device 300 may operate abnormally. On the other hand, the assembling working procedure (assembling work time) is added, so that the damage to the wrist parts 305 can also be reduced, but the defect is that the assembly cost of the lens driving device 300 may be increased.

### BRIEF SUMMARY OF THE INVENTION

The foregoing and other exemplary purposes, aspects and advantages of the present invention will be better understood in principle from the following detailed description of one or more exemplary embodiments of the invention with reference to the drawings, in which:

In view of the above-mentioned problem, the present invention aims to provide a shaking correction device for a camera, and the shaking correction device can be produced at a low cost without adding the assembling working procedure of the lens driving device, and the shaking correction device is of a simple structure whatever the size and mounting position of the lens driving device are.

A shaking correction device includes: one or more movable parts, one or more stators (fixed parts) and one or more driving mechanisms. The movable part includes a movable shaft extending along the direction orthogonal to the Z axis direction when the direction of the optical axis of a lens is taken as the Z axis direction, and hammer parts connected to the movable shafts. The stators (fixed parts) are fixed on a frame body provided with a lens driving device for the movable shafts to run through, and thus the movable parts are supported to be enabled to move. The driving mechanisms are used for driving the movable parts towards the extending directions of the movable shafts.

The shaking correction device is provided with the driving mechanisms, if the movable parts are driven synchronously with the shaking generated by the frame body, the stators can receive counter-acting force relative to the driving of the movable parts when the frame body is shaken, and thus the frame body connected with the stators can be push back so as to overcome the shaking Therefore, the lens driving device retained on the frame body and the frame body are pushed back together towards the direction opposite to the shaking direction, and thus the lens driving device does not swing by assembling the added components, and the components are mounted on the frame body simply, so that the shaking generated by the lens driving device can be reduced.

Therefore, the shaking correction device can be produced at a low cost without increasing the assembling workload, and the shaking correction device can be assembled at any position of the inner side and the outer side of the frame body whatever the size and mounting position of the lens driving device are, so the shaking correction can be realized by using the simple structure.

Moreover, as a preferable embodiment of the present invention, rectilinear driving or rotational driving is carried out by the driving mechanisms.

Therefore, the shaking (rectilinear swing) based on rectilinear movement or shaking generated by the rotational movement (swing like rotating) can be effectively reduced.

Moreover, the summary of the invention does not list all features required by the present invention, and auxiliary combination of these features can also become the present invention.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1 is a perspective view of a mobile phone with a camera provided with a shaking correction device in according to a first embodiment of the present invention;

FIG. 2 is a perspective view of a first rectilinear driving mechanism;

FIG. 3 is a perspective view of the mobile phone with the camera provided with a shaking correction device in according to a second embodiment of the present invention;

FIG. 4 is a perspective view of a first rotational driving mechanism;

FIG. 5 is a perspective view of the mobile phone with the camera provided with another shaking correction device in according to a transformation embodiment of the second embodiment; and

FIG. 6 is a perspective view of an existing shaking correction device.

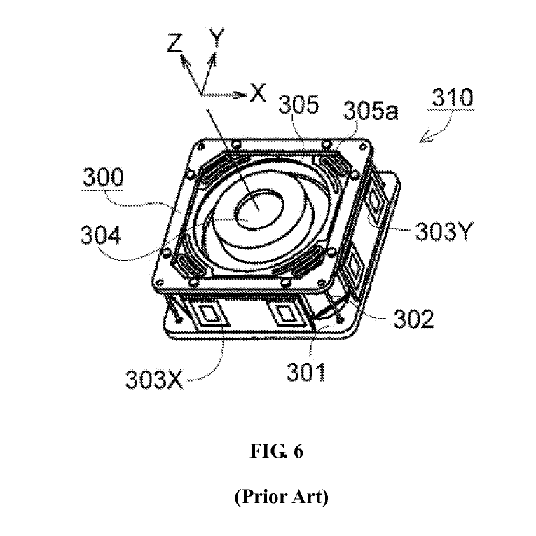

### DETAILED DESCRIPTION OF THE INVENTION

The invention will now be described in detail through several embodiments with reference to the accompanying drawings, but the following embodiments do not limit claims in the present invention, and the combination of all features described in the embodiments does not necessary for solutions of the present invention.

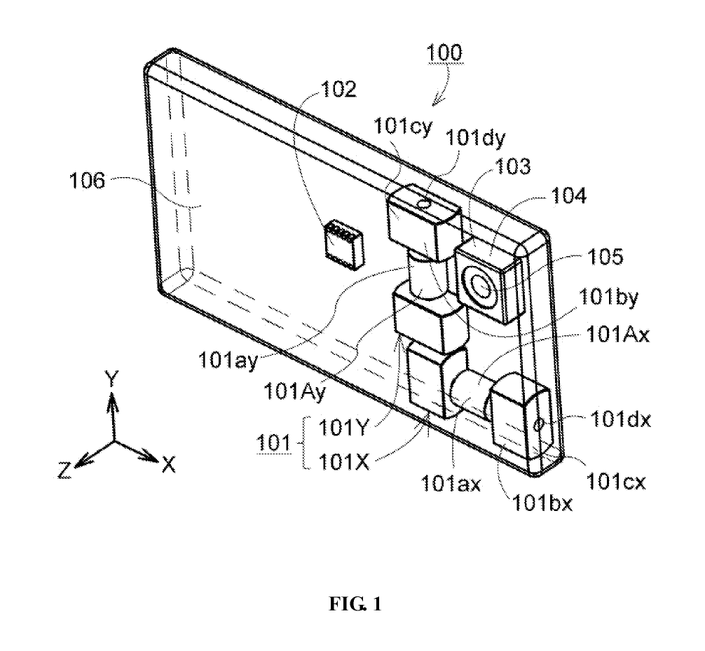

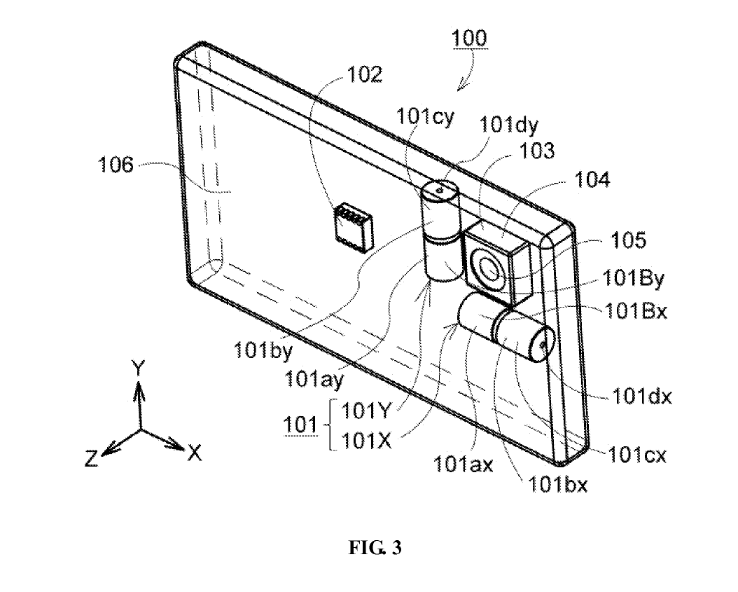

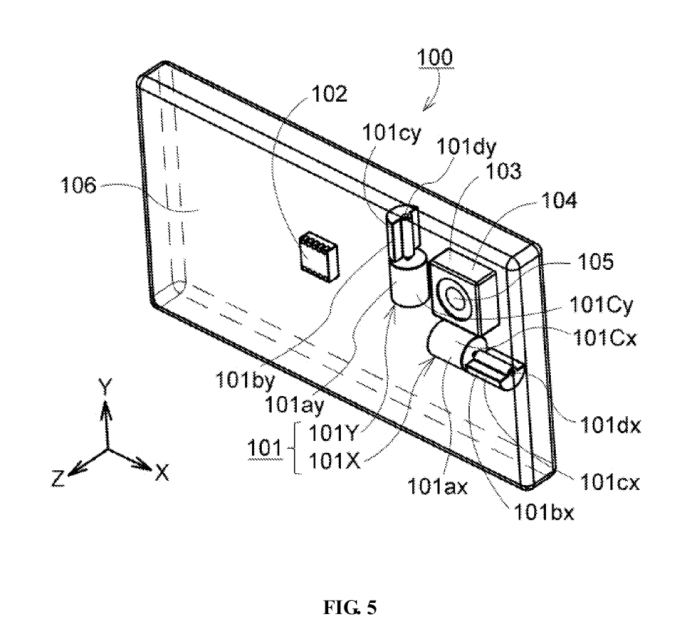

FIG. 1 is a perspective view of a mobile phone 100 with a camera provided with a shaking correction device 101 in according to the first embodiment. Hereinafter, in the Specification, the optical axis of an aftermentioned lens 105 is taken as the Z axis, the side of an object to be shot is taken as the front of the Z axis (+Z side, the front side of the Z axis), and two axes which are orthogonal to the Z axis and are orthogonal to each other are X axis and Y axis respectively. Moreover, in FIG. 1, FIG. 3 and FIG. 5, in order to enable each component in the interior of the frame body 106 to be visual, the state that the interior is visible is shown.

A lens 105 by taking the Z axis direction as the optical axis and the +Z side as the side of the object and a lens driving device 104 for retaining the lens 105 are respectively mounted inside the frame body 106 of the mobile phone 100 with the camera.

An unshown image sensor is mounted on the −Z side of the lens driving device 104. A camera assembly 103 with the camera function is composed of the lens 105, the lens driving device 104 and the image sensor. Moreover, a shaking sensor 102 and the shaking correction device 101 are mounted inside the fame body 106.

The lens driving device 104 is formed to be rectangle-shaped, and is used for retaining the lens 105 in a surrounding manner. The lens driving device 104 enables the lens 105 to move along the Z axis direction, so that the image of the object positioned on the +Z side is focused and imaged on the image sensor disposed on the −Z side of the lens driving device 104. Moreover, the camera assembly 103 with the lens driving device 104 utilizes the lens 105 which is moved to an appropriate position in the Z axis direction, so that a focused image of the object is obtained in the image sensor.

The shaking sensor 102 is assembled near the center of the frame body 106 for instance, when the image of the object is focused and imaged on the image sensor, the amplitude of rectilinear shaking (vibration) in the X axis direction and the amplitude of rectilinear shaking (vibration) in the Y axis direction applied onto the frame body 106 are detected, and informations referring to the vibration direction and the vibration amplitude are sent out to an unshown control circuit.

The shaking correction device 101 includes an X side shaking correction device 101X for correcting the rectilinear shaking generated in the X axis direction and a Y side shaking correction device 101Y for correcting the rectilinear shaking generated in the Y axis direction.

Moreover, due to the X side shaking correction device 101X and the Y side shaking correction device 101Y are of an approximately same structure, under the condition that the X side shaking correction device 101X and the Y side shaking correction device 101Y do not need to be distinguished in the following description, the X side shaking correction device 101X and the Y side shaking correction device 101Y are generally called “the shaking correction device 101”.

The X side shaking correction device 101X includes a first rectilinear driving mechanism 101Ax mounted in the frame body 106. By driving the first rectilinear driving mechanism 101Ax to move in the X axis direction, the movement can be generated. Moreover, the Y side shaking correction device 101Y includes a second rectilinear driving mechanism 101Ay mounted in the frame body 106. By driving the second rectilinear driving mechanism 101Ay to move in the Y axis direction, the movement can be generated.

Moreover, the first rectilinear driving mechanism 101Ax and the second rectilinear driving mechanism 101Ay are driven by appropriate strength at the same time respectively, both of the first rectilinear driving mechanism 101Ax and the second rectilinear driving mechanism 101Ay can be taken as the shaking correction device 101 to drive and move in any direction orthogonal to the Z axis.

As one component of the shaking correction device 101, the X side shaking correction device 101X (the first rectilinear driving mechanism 101Ax) includes a first stator 101ax and a first movable part 101bx. And the first stator 101ax is fixed on the frame body 106. The first movable part 101bx includes a first rod-shaped movable shaft 101dx extending along the X axis direction and two first hammer parts 101cx arranged at the two ends of the first stator 101ax for increasing the weight.

The first stator 101ax is formed to be cylinder-shaped. Unshown bearings are arranged at the two ends of the first stator 101ax in the X axis direction, so that the first movable part 101bx (namely, the first movable shaft 101dx running through the center of the first stator 101ax along the X axis direction and the approximately rectangle-shaped first hammer parts 101cx connected with the two ends of the first movable shaft 101dx) is supported to be enabled to rectilinearly move along the X axis direction.

An unshown coil for driving the first movable part 101bx winding around the axis parallel to the X axis is mounted on the inner wall of the cylinder-shaped first stator 101ax. An unshown magnet is mounted inside the first movable part 101bx, and the coil and the magnet are oppositely arranged along the X axis direction. Moreover, the mounting positions of the coil and the magnet are not limited to the above-mentioned examples, the magnet can also be mounted on the first stator 101ax, and the coil is wound on the first movable part 101bx.

Thus, the coil is electrified in the first rectilinear driving mechanism 101Ax, so that the coil and the magnet can mutually generate attractive force or repulsive force in the X axis direction, and the attractive force or repulsive force in the X axis direction can be generated between the first stator 101ax and the first movable part 101bx.

When the X side shaking correction device 101X (the first rectilinear driving mechanism 101Ax) is rotated by 90 degrees around the Z axis, the Y side shaking correction device 101Y (the second rectilinear driving mechanism 101Ay) is formed. The Y side shaking correction device 101Y includes a second stator 101ay and a second movable part 101by. And the second stator 101ay is fixed on the frame body 106. The second movable part 101by includes a second rod-shaped movable shaft 101dy and two second hammer parts 101cy. The second movable shaft 101dy extends along the Y axis direction and runs through the second stator 101ay, and the second hammer parts 101cy are arranged at the two ends of the second stator 101ay for increasing the weight.

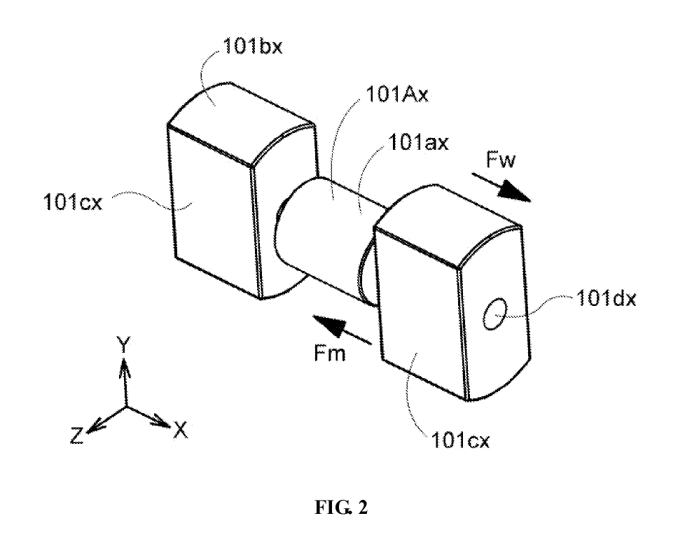

FIG. 2 is an amplified perspective view of the X side shaking correction device 101X (the first rectilinear driving mechanism 101Ax).

As shown in FIG. 2, as one component of the shaking correction device 101, the X side shaking correction device 101X (the first rectilinear driving mechanism 101Ax) is driven to move rectilinearly (rectilinearly driven) by the above-mentioned electromagnetic driving mechanisms (the coil and the magnet).

Specifically, when the unshown coil is electrified, electromagnetic driving force Fw is applied to the first movable part 101bx in the +X axis direction or the −X axis direction (moreover, the electromagnetic driving force Fw as shown in FIG. 2 is in the +X axis direction). On the other hand, the first movable part 101bx is supported by the first stator 101ax so as to be enabled to move in the X axis direction, and thus the first stator 101ax receives the counter-acting force Fm from the first movable part 101bx in the −X axis direction corresponding to the electromagnetic driving force Fw in the +X axis direction applied onto the first movable part 101bx.

Thus, the counter-acting force Fm is transmitted onto the frame body 106 connected with the first stator 101ax, and the frame body 106 can move in the same direction as that of the counter-acting force Fm. That is to say, the driven direction of the frame body 106 and the first stator 101ax can be mutually opposite to the driven direction of the first movable part 101bx.

Referring to FIG. 1 and FIG. 2, a shaking correction method based on the shaking correction device 101 is described.

During the rectilinear shaking (vibration) in a direction (X axis direction, Y axis direction) orthogonal to the Z axis is applied onto the frame body 106, the vibration is detected by the shaking sensor 102, and control current based on the detected shaking information and the vibration amplitude is synchronously generated by the unshown control circuit of the shaking correction device 101. The control current is distributed into the X side shaking correction device 101X and the Y side shaking correction device 101Y according to an X-component amplitude of the shaking in the X axis direction and a Y-component amplitude of the shaking in the Y axis direction.

Namely, when the current is introduced into the coil of the X side shaking correction device 101X (the first rectilinear driving mechanism 101Ax) according to the X-component amplitude of the shaking (vibration) in the X axis direction, the electromagnetic driving force Fw in the X axis direction is applied to the first movable part 101bx, and the first stator 101ax receives the counter-acting force Fm corresponding to the electromagnetic driving force Fw. Moreover, when the current is introduced into the coil of the Y side shaking correction device 101Y (the second rectilinear driving mechanism 101Ay) according to the Y-component amplitude of the shaking (vibration) in the Y axis direction, the electromagnetic driving force Fw in the Y axis direction is applied to the second movable part 101by, and the second stator 101ay receives the counter-acting force Fm corresponding to the electromagnetic driving force Fw in the Y axis direction.

Thus, the frame body 106 is pushed back correspondingly in the direction opposite to the vibrating direction generated by the shaking by the first movable part 101bx of the X side shaking correction device 101X (the first rectilinear driving mechanism 101Ax) and the second movable part 101by of the Y side shaking correction device 101Y (the second rectilinear driving mechanism 101Ay). As a result, the lens driving device 104 mounted in the frame body 106 is pushed back in the direction opposite to the direction of the vibration generated by the shaking, and the vibrating generated by the shaking is reduced.

In this way, the X side shaking correction device 101X can correct the shaking in the X axis direction applied onto the frame body 106, and the Y side shaking correction device 101Y can correct the shaking in the Y axis direction applied onto the frame body 106.

As mentioned above, according to the present invention, the lens driving device 104 can be manufactured at a low cost without the hidden danger that the lens driving device 104 is damaged, and the shaking correction can be realized by using the simple structure. Moreover, the shaking correction device 101 can be assembled at any part inside or outside the frame body 106 whatever the size and mounting position of the lens driving device 104 are.

Moreover, in the first embodiment, the shaking correction device 101 includes the X side shaking correction device 101X for correcting the shaking in the X axis direction and the Y side shaking correction device 101Y for correcting the shaking in the Y axis direction, but the shaking correction device 101 can also include any of the X side shaking correction device 101X and the Y side shaking correction device 101Y so as to correct any of the shaking in the X axis direction and the shaking in the Y axis direction.

FIG. 3 is a perspective view of a mobile phone 100 with a camera provided with a shaking correction device 101 in according to a second embodiment. In the second embodiment, the manner that a first rotational driving mechanism 101Bx and a second rotational driving mechanism 101By for driving rotation are mounted is different from that in the first embodiment.

A lens 105 by taking the +Z side as the side of the object to be shot and a lens driving device 104 for retaining the lens 105 are respectively mounted inside the frame body 106 of the mobile phone 100 with the camera. The unshown image sensor is mounted on the −Z side of the lens driving device 104. The camera assembly 103 includes the lens 105, the lens driving device 104 and the image sensor so as to be taken as the camera for taking effect. Moreover, the shaking sensor 102 and the shaking correction device 101 are mounted in the fame body 106.

The lens driving device 104 enables the lens 105 to move along the Z axis direction, so that the image of the object on the +Z side is focused and imaged on the image sensor disposed on the −Z side of the lens driving device 104. Namely, the camera assembly 103 obtains the focused image of the object in the image sensor by the lens 105 moving to the appropriate position in the Z axis direction.

When the image of the object is focused and imaged on the image sensor, after the shaking sensor 102 detects the amplitude of the shaking (rotational vibration) rotating around the X axis applied onto the frame body 106, and the amplitude of the shaking (rotational vibration) rotating around the Y axis applied onto the frame body 106, the information referring to the vibration direction and the vibration amplitude are sent out to the unshown control circuit.

The shaking correction device 101 includes the X side shaking correction device 101X for correcting the rotational shaking generated in the X axis direction and the Y side shaking correction device 101Y for correcting the rotational shaking generated in the Y axis direction.

The X side shaking correction device 101X includes a first rotational driving mechanism 101Bx mounted in the frame body 106. By driving the first rotational driving mechanism 101Bx to move in the X axis direction, the movement of the frame body 106 can be generated. The Y side shaking correction device 101Y includes a second rotational driving mechanism 101By mounted in the frame body 106. By driving the second rotational driving mechanism 101By to move in the Y axis direction, the movement of the frame body 106 can be generated.

Moreover, the first rotational driving mechanism 101Bx and the second rotational driving mechanism 101By are driven at appropriate strength at the same time respectively, then the first rotational driving mechanism 101Bx and the second rotation driving mechanism 101By can be taken as the shaking correction device 101 to drive and move in any direction orthogonal to the Z axis.

As one component of the shaking correction device 101, the X side shaking correction device 101X (the first rotational driving mechanism 101Bx) includes the first stator 101ax and the first movable part 101bx. And the first stator 101ax is fixed on the frame body 106. The first movable part 101bx includes a first rod-shaped movable shaft 101dx extending along the X axis direction and a first hammer part 101cx arranged at a single end of the first stator 101ax for increasing the weight.

The first stator 101ax is formed to be cylinder-shaped. An unshown bearings are arranged at the two ends of the first stator 101ax in the X axis direction, so that the first movable part 101bx (namely, the first movable shaft 101dx running through the center of the first stator 101ax along the X axis direction and the approximately columnar-shaped first hammer part 101cx connected with the first movable shaft 101dx) is supported to be enabled to rotationally move around the X axis direction.

An unshown coil wound around an axis perpendicular to the X axis is mounted on the inner wall of the cylinder-shaped first stator 101ax. An unshown magnet is mounted in the first movable part 101bx, and the coil and the magnet are oppositely arranged along the direction perpendicular to the X axis. Moreover, the mounting positions of the coil and the magnet are not limited to the above-mentioned examples, the magnet can also be mounted on the first stator 101ax, and the coil is wound on the first movable part 101bx.

Thus, the coil is electrified in the first rotational driving mechanism 101Bx, so that the coil and the magnet can mutually generate rightward or leftward rotational torque in the X-axis direction, and the rightward or leftward rotational torque in the X axis direction can be generated between the first stator 101ax and the first movable part 101bx.

The Y side shaking correction device 101Y (the second rotational driving mechanism 101By) enables the first rotational driving mechanism 101Bx to rotate by 90 degrees around the Z axis so as to form the Yside shaking correction device 101Y (the second rotational driving mechanism 101By). The Y side shaking correction device 101Y includes the second stator 101ay and the second movable part 101by. And the second stator 101ay is fixed on the frame body 106. The second movable part 101by includes a second rod-shaped movable shaft 101dy and a second hammer part 101cy. The second movable shaft 101dy extends along the Y axis direction and runs through the second stator 101ay, and the second hammer part 101cy is arranged at the single end of the second stator 101ay.

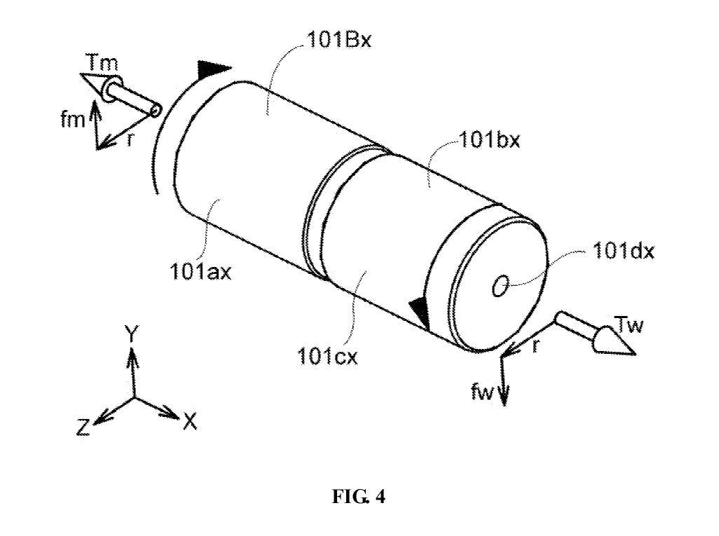

FIG. 4 is an amplified perspective view of the X side shaking correction device 101X (the first rotational driving mechanism 101Bx).

As shown in FIG. 4, as one component of the shaking correction device 101, the X side shaking correction device 101X (the first rotational driving mechanism 101Bx) utilizes the above-mentioned electromagnetic driving mechanisms (the coil and the magnet) to carry out driving rotation (rotational driving).

Specifically, when the unshown coil is electrified, electromagnetic driving torque Tw in the +X axis direction or −X axis direction, namely in the rightward rotational direction or leftward rotational direction of +X axis is applied to the movable part 101bx based on a current direction. As an embodiment, the electromagnetic driving torque Tw in the +X axis direction is applied to the first movable part 101bx as shown in FIG. 4, and an electromagnetic driving force fw rotating rightwards around the +X axis is applied at the position with a distance of r from a rotating shaft. On the other hand, the first movable part 101bx is supported by the first stator 101ax so that the first movable part 101bx can rotate in the X axis direction, and thus the first stator 101ax receives counter-acting force torque Tm in the −X axis direction corresponding to the electromagnetic driving torque Tw in the +X axis direction applied onto the first movable part 101bx. Namely the first stator 101ax further receives counter-acting force fm rotating leftwards around the +X axis with the strength the same as that of the operated electromagnetic driving force fw at the position with a distance of r from the X axis.

Thus, the counter-acting force torque Tm is transmitted to the frame body 106 connected with the first stator 101ax, and the frame body 106 can rotate and move in the direction of the counter-acting force torque Tm. That is to say, the rotation direction of the frame body 106 and the first stator 101ax is mutually opposite to the rotation direction of and the first movable part 101bx.

Therefore, when the shaking (vibration) rotating around the axe (X axis direction, Y axis direction) orthogonal to the Z axis is applied to the frame body 106, the vibration generated with the rotation is detected by the shaking sensor 102, and the control current based on the detected shaking information and the vibration amplitude is synchronously supplied to the shaking correction device 101 from the unshown control circuit. The control current is distributed into the X side shaking correction device 101X and the Y side shaking correction device 101Y according to the component amplitudes of the shaking rotating around the X axis and the Y axis.

Namely, when the current corresponding to the component amplitude of the shaking rotating around the X axis is introduced into the coil mounted in the X side shaking correction device 101X (the first rotational driving mechanism 101Bx), the electromagnetic driving torque Tw rotating in the X axis direction is applied to the first movable part 101bx, and the first stator 101ax receives the counter-acting force torque Tm corresponding to the electromagnetic driving torque Tw.

Moreover, when the current corresponding to the component amplitude of the shaking rotating around the X axis is introduced into the coil mounted in the Y side shaking correction device 101Y (the second rotational driving mechanism 101By), the electromagnetic driving torque Tw rotating in the Y axis direction is applied to the second movable part 101by, and the second stator 101ay receives the counter-acting force torque Tm corresponding to the electromagnetic driving torque Tw.

Thus, the frame body 106 is pushed back corresponding to the direction opposite to the vibration direction generated by the shaking by the first movable part 101bx of the X side shaking correction device 101X (the first rotational driving mechanism 101Bx) or the second movable part 101by of the Y side shaking correction device 101Y (the second rotational driving mechanism 101By). As a result, the lens driving device 104 mounted in the frame body 106 is pushed back towards the direction opposite to the vibration direction based on the shaking, and thus the vibration generated based on the shaking is reduced.

In this way, the X side shaking correction device 101X can correct the shaking rotating around the X axis and applied to the frame body 106, and the Y side shaking correction device 101Y can correct the shaking rotating around the Y axis and applied on the frame body 106.

As mentioned above, according to the present invention, the lens driving device 104 can be produced at a low cost without damaging the lens driving device 104, and the shaking correction can be realized by utilizing the simple structure. Moreover, the shaking correction device 101 can be assembled at any part inside or outside the frame body 106 whatever the size and mounting position of the lens driving device 104 are.

Moreover, in the second embodiment, the shaking correction device 101 includes the X side shaking correction device 101X for correcting the shaking in the X axis direction and the Y side shaking correction device 101Y for correcting the shaking in the Y axis direction, but the shaking correction device 101 can also includes any of the X side shaking correction device 101X and the Y side shaking correction device 101Y so as to correct any of the shaking in the X axis direction and the shaking in the Y axis direction.

FIG. 5 is a perspective view of the mobile phone 100 with a camera provided with the shaking correction device 101 in according to a transformation embodiment of the second embodiment. The difference between the first movable part 101bx and the second movable part 101by in the transformation embodiment and the second embodiment lies in that the shapes of the first hammer part 101cx and the second hammer part 101cy are respectively formed to be approximately semicircle-shaped eccentric from the movable shafts of the first movable shaft 101dx and the second movable shaft 101dy.

The lens 105 by taking the +Z side as the side of the object and the lens driving device 104 for retaining the lens 105 are respectively mounted in the frame body 106 of the mobile phone 100 with a camera. The unshown image sensor is mounted on the −Z side of the lens driving device 104. The camera assembly 103 includes the lens 105, the lens driving device 104 and the image sensor. The shaking sensor 102 and vibration motors 101Cx and 101Cy acting as the first rotational driving mechanism 101Bx and the second rotational driving mechanism 101By in the shaking correction device 101 are respectively mounted in the frame body 106.

Namely, in the transformation embodiment, the two vibration motors 101Cx and 101Cy are mounted in the frame body 106 in the manner that rotating shafts of the vibration motors 101Cx and 101Cy are respectively parallel to the X axis direction and the Y axis direction so as to replace the first rotational driving mechanism 101Bx and the second rotational driving mechanism 101By as shown in FIG. 3 (the second embodiment).

The vibration motors 101Cx and 101Cy of the shaking vibration device 101 are components for rotating the hammer parts 101cx and 101cy when the mobile phone 100 with a camera receives phone calls or E-mails so as to vibrate the frame body and remind users of incoming calls or incoming mails.

That is to say, the shaking correction device 101 of the transformation embodiment can be taken as the shaking correction device 101 illustrated in the second embodiment as shown in FIG. 3, and the vibration motors 101Cx and 101Cy can also be taken as vibrators so as to generate vibration when receiving the incoming calls or incoming mails.

Therefore, when the shaking (vibration) rotating around the axe (X axis direction, Y axis direction) orthogonal to the Z axis is applied onto the frame body 106, the vibration is detected by the shaking sensor 102, and the control current based on the detected shaking information and the vibration amplitude is synchronously supplied to the shaking correction device 101 from the unshown control circuit. The control current is distributed into the X side shaking correction device 101X and the Y side shaking correction device 101Y according to the X-component and the Y-component of the shaking.

As a result, similar to the example as shown in FIG. 3, the lens driving device 104 is pushed back in the direction opposite to the vibration direction based on the shaking so as to reduce the vibration generated by the shaking. In this way, the vibration motor 101Cx acting as the X side shaking correction device 101X (the first rotational driving mechanism 101Bx) can correct the shaking rotating around the X axis applied to the frame body 106, and the vibration motor 101Cy acting as the Y side shaking correction device 101Y (the second rotational driving mechanism 101By) can correct the shaking rotating around the Y axis applied to the frame body 106.

As mentioned above, in the transformation embodiment, the shaking correction device 101 includes the X side shaking correction device 101X for correcting the shaking rotating around the X axis and the Y side shaking correction device 101Y for correcting the shaking rotating around the Y axis, but the shaking correction device 101 can also includes only one of the X side shaking correction device 101X and the Y side shaking correction device 101Y so as to only correct one of the shaking rotating around the X axis and the shaking rotating around the Y axis.

As mentioned above, according to the present invention, the lens driving device 104 can be produced at a low cost without the hidden danger that the lens driving device 104 is damaged, and the shaking correction can be realized by using the simple structure. Moreover, the shaking correction device 101 can be assembled at any part inside or outside the frame body 106 whatever the size and mounting position of the lens driving device 104 are.

For example, in the Specification, only the example that the first rectilinear driving mechanism and the second rectilinear driving mechanism 101Ax and 101Ay which are capable of rectilinear driving and the first rotational driving mechanism 101Bx and the second rotational driving mechanism 101By which are capable of rotational driving are independently mounted in the frame body 106 respectively is illustrated, but it is not limited to this, the two types of the first rectilinear driving mechanism and the second rectilinear driving mechanism 101Ax and 101Ay and the first rotational driving mechanism and the second rotational driving mechanism 101Bx and 101By can also be mounted in the frame body 106 together. From this, the shaking correction with high precision can be realized for the rectilinear shaking and the rotational shaking at the same time.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A shaking correction device, comprising:
one or more movable parts, each movable part comprising:
a movable shaft extending along a direction orthogonal to a Z axis direction when an optical axis of a lens is taken as the Z-axis, and
one or more hammer parts connected with the movable shaft;
one or more stators fixed on a frame body provided with a lens driving device for driving the lens, and each stator being run through by a movable shaft of a corresponding one of the one or more movable parts so that the corresponding one of the movable parts is supported to be enabled to move; and
one or more driving mechanisms configured for driving the one or more movable parts to move towards extending directions of the one or more movable shafts so that the one or more stators receive corresponding counter-acting forces corresponding to the driving forces supplied to the one or more movable parts.

2. The shaking correction device according to claim 1, wherein the one or more driving mechanisms carry out rectilinear driving or rotational driving.
